(19) United States
(12) Patent Application Publication
(10) Pub. No.: US 2026/0269107 A1
(43) Pub. Date: Sep. 10, 2026

(54) RESISTOR AND METHOD FOR MANUFACTURING THE SAME

(71) Applicant: YAGEO CORPORATION, Kaohsiung City (TW)

(72) Inventors: Ming-Hung HSIAO, Kaohsiung City (TW); Chun-Kai YANG, Kaohsiung City (TW); Jia-You LAI, Kaohsiung City (TW)

(21) Appl. No.: 19/201,965

(22) Filed: May 8, 2025

(30) Foreign Application Priority Data
Mar. 6, 2025 (TW) 114108302

(51) Int. Cl. H01C 1/032

(52) U.S. Cl. CPC H01C 1/032

(57) ABSTRACT

A resistor includes a resistance layer, first and second insulating protection layers, first and second thermal conductive layers, and first and second terminal electrode structures. The resistance layer has opposite first and second surfaces, each of which includes a central portion and first and second end portions, and opposite first and second end surfaces. The first and second insulating protection layers are respectively disposed on the central portions of the first and second surfaces. The first and second thermal conductive layers are separated and respectively extend from the first and second end portions of the first surface to the first insulating protection layer. The first insulating protection layer is longer than the second insulating protection layer. The first and second terminal electrode structures are opposite to and separated from each other, and respectively extend from the first and second thermal conductive layers to the second insulating protection layer.

### CROSS-REFERENCE TO RELATED APPLICATIONS

This application claims priority to Taiwan Application Serial Number 114108302, filed Mar. 6, 2025, which is herein incorporated by reference in its entirety.

### BACKGROUND

### Field of Invention

The present disclosure relates to a technology for manufacturing an electronic component, and more particularly, to a resistor and a method for manufacturing the same.

### Description of Related Art

A heat sink of a resistor is typically adhered to one side of the resistor where a resistance layer is located through an insulating bonding layer to form a three-layer stacked structure. The insulating bonding layer is located between the heat sink and the resistance layer, such that the heat sink does not directly contact with the resistance layer. Because the insulating bonding layer is located between the heat sink and the resistive layer, such a design cannot effectively dissipate heat from the resistance layer. In addition, when the resistor is operated at high power for a long time, the insulating bonding layer is easily affected by heat and becomes brittle, which causes electrical failure of the resistor.

Furthermore, the structure that uses the insulating bonding layer to adhere the heat sink to the resistance layer is thicker. Therefore, such a design makes it difficult to produce small-sized surface mount devices (SMD), such as products below 0805 type (2mm*1.2 mm), which is not conducive to high power, thin, and light requirements required for thin and light electronic products.

### SUMMARY

Therefore, one objective of the present disclosure is to provide a resistor and a method for manufacturing the same, which can solve the problems that the structure of the conventional resistor cannot effectively conduct heat out of the resistance layer and cannot meet the requirements of thin and light electronic products.

According to the aforementioned objectives, the present disclosure provides a resistor, which includes a resistance layer, a first insulating protection layer, a first thermal conductive layer, a second thermal conductive layer, a second insulating protection layer, a first terminal electrode structure, and a second terminal electrode structure. The resistance layer has a first surface and a second surface that are opposite to each other, and a first end surface and a second end surface that are opposite to each other. Each of the first surface and the second surface includes a central portion, and a first end portion and a second end portion respectively located on two opposite sides of the central portion. The first insulating protection layer is disposed on the central portion of the first surface. The first thermal conductive layer and the second thermal conductive layer respectively extend from the first end portion and the second end portion of the first surface to the first insulating protection layer and are separated from each other. The second insulating protection layer is disposed on the central portion of the second surface. A length of the first insulating protection layer is greater than a length of the second insulating protection layer. The first terminal electrode structure covers the first thermal conductive layer, the first end surface, the first end portion of the second surface, and a portion of the second insulating protection layer. The second terminal electrode structure is opposite to and separated from the first terminal electrode structure, and covers the second thermal conductive layer, the second end surface, the second end portion of the second surface, and another portion of the second insulating protection layer.

According to one embodiment of the present disclosure, a difference between the length of the first insulating protection layer and the length of the second insulating protection layer is equal to or greater than 100 μm.

According to one embodiment of the present disclosure, the length of the second insulating protection layer is ranging from ⅕ to ⅗ of a length of the resistance layer.

According to one embodiment of the present disclosure, each of the first thermal conductive layer and the second thermal conductive layer includes a first portion and a second portion. The second portion is connected to the first portion to form a T-shaped structure. A width of the second portion is smaller than a width of the first portion. The second portion of the first thermal conductive layer and the second portion of the second thermal conductive layer are opposite to each other.

According to one embodiment of the present disclosure, a distance between the first thermal conductive layer and the second thermal conductive layer is ranging from ⅕ to ⅓ of a length of the resistance layer, the width of the first portion is ranging from ⅘ to 1 of a width of the resistance layer, and a difference between the width of the first portion and the width of the second portion is ranging from 100 μm to 200 μm.

According to one embodiment of the present disclosure, the first terminal electrode structure includes a first internal electrode and a first external electrode covering the first internal electrode. The second terminal electrode structure includes a second internal electrode and a second external electrode covering the second internal electrode. The first internal electrode and the second internal electrode are respectively embedded in the first end portion and the second end portion of the second surface. The first external electrode extends from the first thermal conductive layer through the first end surface to the first internal electrode. The second external electrode extends from the second thermal conductive layer through the second end surface to the second internal electrode.

According to one embodiment of the present disclosure, each of the first external electrode and the second external electrode includes a copper layer, a nickel layer, and a tin layer sequentially stacked from inside to outside. A distance between a bottom surface of the copper layer and a bottom surface of the second insulating protection layer is greater than 5 μm.

According to the aforementioned objectives, the present disclosure further provides a method for manufacturing a resistor. In this method, a carrier is used to carry a resistance layer. The resistance layer has a first surface and a second surface that are opposite to each other, and a first end surface and a second end surface that are opposite to each other. The first surface is adhered to the carrier. Each of the first surface and the second surface includes a central portion, and a first end portion and a second end portion respectively located on two opposite sides of the central portion. Portions of the resistance layer are removed to form a first concave and a second concave in the first end portion and the second end portion of the second surface respectively. A first internal electrode and a second internal electrode are formed in the first concave and the second concave respectively. The carrier is removed. A first insulating protection layer and a second insulating protection layer are formed on the central portion of the first surface and the central portion of the second surface respectively. A length of the first insulating protection layer is greater than a length of the second insulating protection layer. A first thermal conductive layer and a second thermal conductive layer are formed, in which the first thermal conductive layer and the second thermal conductive layer respectively extend from the first end portion and the second end portion of the first surface to the first insulating protection layer and are separated from each other. A first external electrode and a second external electrode are formed. The first external electrode extends from the first thermal conductive layer through the first end surface to the first internal electrode. The second external electrode extends from the second thermal conductive layer through the second end surface to the second internal electrode.

According to one embodiment of the present disclosure, a depth of each of the first concave and the second concave is ranging from 20 μm to 50 μm.

According to one embodiment of the present disclosure, before forming the first insulating protection layer and the second insulating protection layer, the method for manufacturing a resistor further includes performing a trimming operation on the central portion of the second surface of the resistance layer to remove a portion of the resistance layer.

According to one embodiment of the present disclosure, a difference between the length of the first insulating protection layer and the length of the second insulating protection layer is equal to or greater than 100 μm.

According to one embodiment of the present disclosure, forming the first thermal conductive layer and the second thermal conductive layer includes using a printing method or a sputtering method.

According to one embodiment of the present disclosure, each of the first thermal conductive layer and the second thermal conductive layer includes a first portion and a second portion. The second portion is connected to the first portion to form a T-shaped structure. A width of the second portion is smaller than a width of the first portion. The second portion of the first thermal conductive layer and the second portion of the second thermal conductive layer are opposite to each other.

According to one embodiment of the present disclosure, a distance between the first thermal conductive layer and the second thermal conductive layer is ranging from ⅕ to ⅓ of a length of the resistance layer. The width of the first portion is ranging from ⅘ to 1 of a width of the resistance layer. A difference between the width of the first portion and the width of the second portion is ranging from 100 μm to 200 μm.

According to one embodiment of the present disclosure, each of the first external electrode and the second external electrode includes a copper layer, a nickel layer, and a tin layer sequentially stacked from inside to outside. A distance between a bottom surface of the copper layer and a bottom surface of the second insulating protection layer is greater than 5 μm.

According to the above embodiments, the first thermal conductive layer and the second thermal conductive layer of the resistor of the present disclosure can increase the heat dissipation area and directly contact the resistance layer, such that the heat generated by the resistance layer can be quickly dissipated. Thus, the resistor can be used as a high power current sensing resistor. In addition, the insulating bonding layer is eliminated, such that the resistor can be effectively thinned. Furthermore, the first internal electrode and the second internal electrode are embedded in the resistance layer, such that the thickness of the resistor can be further reduced to achieve a thinning effect.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a schematic three-dimensional diagram of a resistor in accordance with one embodiment of the present disclosure.

FIG. 2 is a schematic top view of a resistor in accordance with one embodiment of the present disclosure.

FIG. 3 is a schematic bottom view of a resistor in accordance with one embodiment of the present disclosure.

FIG. 4 is a schematic cross-sectional view of the resistor taken along a section line A-A of FIG. 1.

FIG. 5 through FIG. 14 are schematic cross-sectional views respectively showing intermediate stages in a method for manufacturing a resistor in accordance with one embodiment of the present disclosure.

FIG. 15 is a top view of the structure of FIG. 12.

FIG. 16 is a bottom view of the structure of FIG. 12.

FIG. 17 is a top view of the structure of FIG. 13.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms “first”, “second”, and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms “connected”, “electrically connected”, or the like between two components referred to in the present disclosure are not limited to the direct connection or electrical connection of the two components, and may also include indirect connection or electrical connection as required.

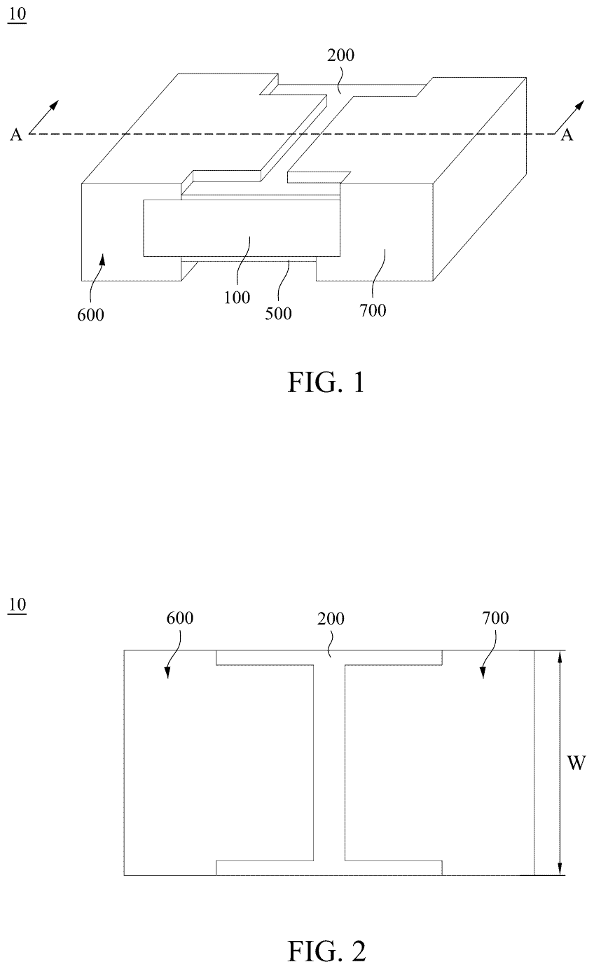

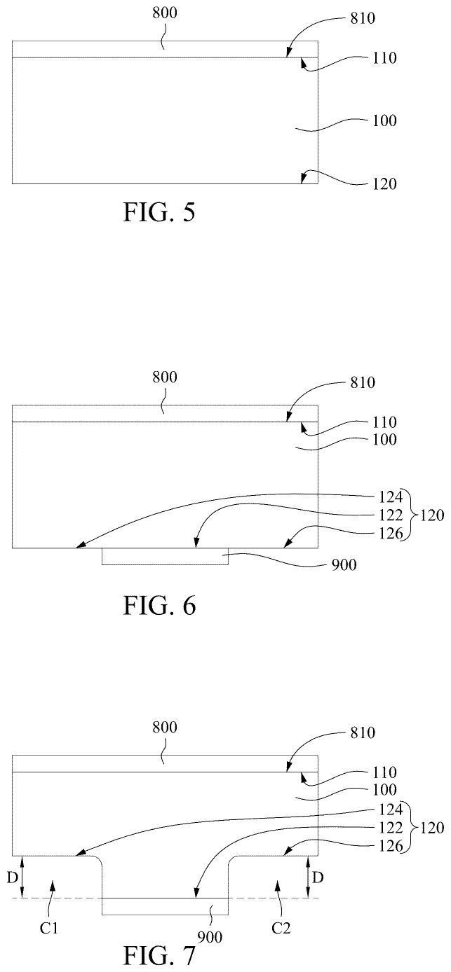

Referring to FIG. 1 through FIG. 4, FIG. 1 through FIG. 4 respectively illustrate a schematic three-dimensional diagram, a schematic top view, and a schematic bottom view of a resistor 10 in accordance with one embodiment of the present disclosure, and a schematic cross-sectional view of the resistor 10 taken along a section line A-A of FIG. 1. The resistor 10 can be used in automotive specification applications, such as automotive charging piles, battery management systems (BMS), and engine control units (ECU), or current sensing applications. As shown in FIG. 4, the resistor 10 ma mainly include a resistance layer 100, a first insulating protection layer 200, a first thermal conductive layer 300, a second thermal conductive layer 400, a second insulating protection layer 500, a first terminal electrode structure 600, and a second terminal electrode structure 700.

The resistance layer 100 may be, for example, a sheet structure. A shape of the resistance layer 100 can be determined according to the product design. For example, the resistance layer 100 may be square or rectangular. As shown in FIG. 4, the resistance layer 100 has a first surface 110 and a second surface 120 that are opposite to each other, and a first end surface 130 and a second end surface 140 that are opposite to each other. For example, the first surface 110 and the second surface 120 may be respectively an upper surface and a lower surface of the resistance layer 100, and the first end surface 130 and the second end surface 140 may be respectively two side surfaces of the resistance layer 100 and are located between the first surface 110 and the second surface 120. The first surface 110 may include a central portion 112, and a first end portion 114 and a second end portion 116 respectively located on two opposite sides of the central portion 112. The second surface 120 may similarly include a central portion 122, and a first end portion 124 and a second end portion 126 respectively located at two opposite sides of the central portion 122. The first end portions 114 and 124 are opposite to each other and adjacent to the first end surface 130, and the second end portions 116 and 126 are opposite to each other and adjacent to the second end surface 140. In some examples, the resistance layer 100 includes at least one trimming groove 150. For example, the trimming groove 150 may be recessed into the central portion 122 of the second surface 120 of the resistance layer 100.

The resistance layer 100 may be a metal alloy. For example, the resistance layer 100 may be a metal alloy, such as copper-manganese alloy (MnCu), copper-nickel alloy (CuNi), copper-manganese-nickel alloy (CuMnNi), copper-manganese-tin alloy (CuMnSn), nickel-chromium-aluminum alloy (NiCrAl), nickel-chromium-aluminum-silicon alloy (NiCrAlSi), iron-chromium-aluminum alloy (FeCrAl), and the like. However, the material of the resistance layer 100 can be other suitable resistance materials, and the present disclosure is not limited thereto.

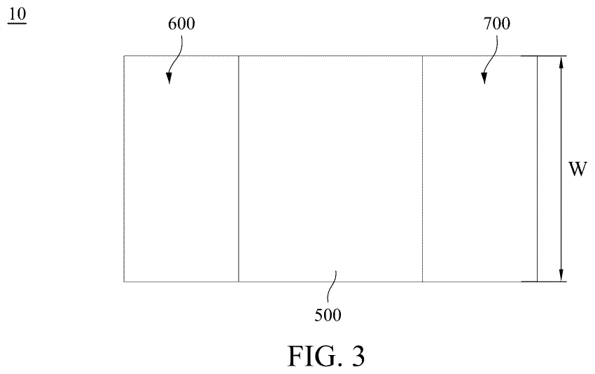

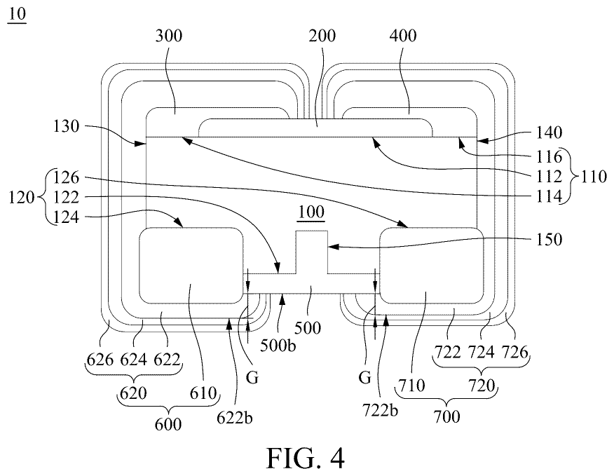

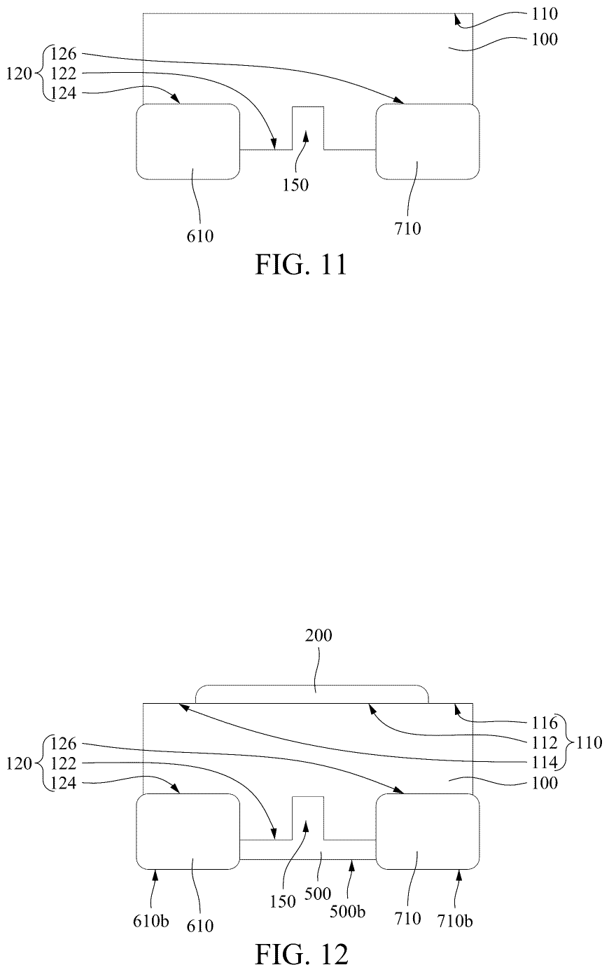

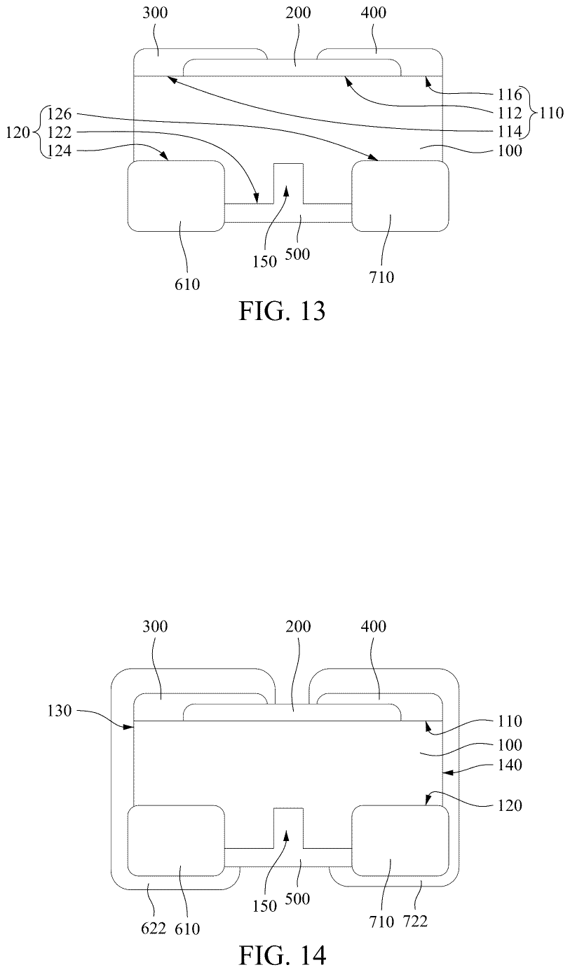

Referring to FIG. 2 and FIG. 4 simultaneously, the first insulating protection layer 200 is disposed on the central portion 112 of the first surface 110 of the resistance layer 100. As shown in FIG. 3 and FIG. 4, the second insulating protection layer 500 is disposed on the central portion 122 of the second surface 120 and is opposite to the first insulating protection layer 200. As shown in FIG. 15 and FIG. 16, based on a current path design, a length GL of the first insulating protection layer 200 has to be greater than a length RL of the second insulating protection layer 500. In some examples, a difference between the length GL of the first insulating protection layer 200 and the length RL of the second insulating protection layer 500, that is, the length GL of the first insulating protection layer 200 minus the length RL of the second insulating protection layer 500, is equal to or greater than 100μm. Thereby, it is more ensured that the path of the current in the resistance layer 100 can be from one of the first terminal electrode structure 600 and the second terminal electrode structure 700 through the portion of the resistance layer 100 over the second insulating protection layer 500 to the other one of the first terminal electrode structure 600 and the second terminal electrode structure 700. If the length GL minus the length RL is smaller than 100 μm, it may not be conducive to production, and thus resulting in a decrease in product yield.

In addition, the length RL of the second insulating protection layer 500 is ranging from ⅕ to ⅗ of the length L of the resistance layer 100. If the length RL of the second insulating protection layer 500 is smaller than ⅕ of the length L of the resistance layer 100, a distance between the first terminal electrode structure 600 and the second terminal electrode structure 700 is too close. As a result, when the resistor 10 is mounted on a circuit board, the solder paste may connect the first terminal electrode structure 600 and the second terminal electrode structure 700, such that a short circuit is formed. If the length RL of the second insulating protection layer 500 is greater than ⅗ of the length L of the resistance layer 100, the first terminal electrode structure 600 and the second terminal electrode structure 700 will be too small, such that it is difficult to mount the resistor 10 on the circuit board.

In some examples, a width of the first insulating protection layer 200 and a width of the second insulating protection layer 500 are equal to or slightly greater than a width W of the resistance layer 100 to completely cover the central portion 112 of the resistance layer 100. For example, materials of the first insulating protection layer 200 and the second insulating protection layer 500 may be epoxy, resin, epoxy with fillers, polyimide (PI) or other insulating materials.

As shown in FIG. 4, the first thermal conductive layer 300 and the second thermal conductive layer 400 are both disposed on the first surface 110 of the resistance layer 100, and cover portions of the first insulating protection layer 200. The first thermal conductive layer 300 and the second thermal conductive layer 400 are separated from each other. The first thermal conductive layer 300 extends from the first end portion 114 of the first surface 110 to a portion of the first insulating protection layer 200. The second thermal conductive layer 400 extends from the second end portion 116 toward the first thermal conductive layer 300 to another portion of the first insulating protection layer 200. The first thermal conductive layer 300 and the second thermal conductive layer 400 provide a heat dissipation function. The first thermal conductive layer 300 and the second thermal conductive layer 400 can form a larger thermal conductive area, and the first thermal conductive layer 300 and the second thermal conductive layer 400 directly contact with the resistance layer 100, such that the heat generated by the resistance layer 100 can be quickly dissipated.

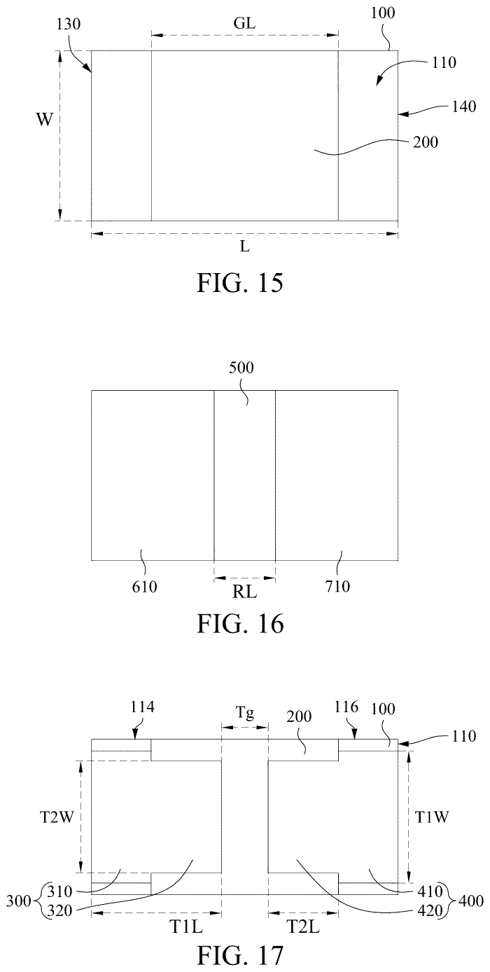

Referring to FIG. 17, in some examples, the first thermal conductive layer 300 includes a first portion 310 and a second portion 320. The second portion 320 is connected to the first portion 310, and a width T2W of the second portion 320 is smaller than a width T1W of the first portion 310, such that a T-shaped structure is formed. Similarly, the second thermal conductive layer 400 includes a first portion 410 and a second portion 420. The second portion 420 is connected to the first portion 410, and a width T2W of the second portion 420 is smaller than a width T1W of the first portion 410, such that a T-shaped structure is formed. The first portions 310 and 410 are respectively located at least on the first end portion 114 and the second end portion 116 of the first surface 110, and the second portions 320 and 420 respectively extend from the first portions 310 and 410 and are opposite to each other on the first insulating protection layer 200. The widths T1W of the first portions 310 and 410 may be the same or different, the widths T2W of the second portions 320 and 420 may be the same or different, and the present disclosure is not limited thereto.

Referring to FIG. 17 again, in some examples, a distance Tg between the first thermal conductive layer 300 and the second thermal conductive layer 400 is ranging from ⅕ to ⅓ of the length L of the resistance layer 100. In addition, the width T1W of the first portions 310 and 410 is ranging from ⅘ to 1 of the width W of the resistance layer 100. A difference between the width T1W of the first portions 310 and 410 and the width T2W of the second portions 320 and 420, that is, the width T1W of the first portions 310 and 410 minus the width T2W of the second portions 320 and 420, is ranging from 100 μm to 200 μm. With such a size design, the thermal conductive areas of the first thermal conductive layer 300 and the second thermal conductive layer 400 can be maximized within the process window. In addition, when the width T2W of the second portions 320 and 420 is within the above range, there are certain distances respectively between the inwardly protruding second portions 320 and 420 and the edges of the resistance layer 100. Thus, it can prevent the solder paste from overflowing and connecting the first thermal conductive layer 300 and the second thermal conductive layer 400 to form a short circuit when the resistor 10 is mounted on the circuit board, and the first terminal electrode structure 600 and the second terminal electrode structure 700 from being exposed on the short sides of the resistor 10 due to the subsequent electroplating.

Referring to FIG. 1 through FIG. 4, the first terminal electrode structure 600 covers the first thermal conductive layer 300, the first end surface 130 of the resistance layer 100, the first end portion 124 of the second surface 120, and a portion of the second insulating protection layer 500. The first terminal electrode structure 600 extends from the first surface 110 of the resistance layer 100 through the first end surface 130 to the second insulating protection layer 500 on the second surface 120, such that a cross-sectional shape of the first terminal electrode structure 600 is similar to a C-shape.

The second terminal electrode structure 700 covers the second thermal conductive layer 400, the second end surface 140 of the resistance layer 100, the second end portion 126 of the second surface 120, and another portion of the second insulating protection layer 500. The second terminal electrode structure 700 extends from the first surface 110 of the resistance layer 100 through the second end surface 140 to the second insulating protection layer 500 on the second surface 120, such that a cross-sectional shape of the second terminal electrode structure 700 is similar to an inverted C shape. The second terminal electrode structure 700 and the first terminal electrode structure 600 are spaced apart from each other.

As shown in FIG. 4, in some examples, the first terminal electrode structure 600 includes a first internal electrode 610 and a first external electrode 620, in which the first external electrode 620 covers the first internal electrode 610. The second terminal electrode structure 700 includes a second internal electrode 710 and a second external electrode 720, in which the second external electrode 720 covers the second internal electrode 710. The first internal electrode 610 and the second internal electrode 710 are respectively embedded in the first end portion 124 and the second end portion 126 of the second surface 120, such that a portion of the first internal electrode 610 and a portion of the second internal electrode 710 are located within the resistance layer 100. For example, materials of the first internal electrode 610 and the second internal electrode 710 may be copper.

As shown in FIG. 4, the first external electrode 620 extends from the first thermal conductive layer 300 on the first surface 110 of the resistance layer 100 through the first end surface 130 to the first internal electrode 610 on the second surface 120. The second external electrode 720 extends from the second thermal conductive layer 400 through the second end surface 140 to the second internal electrode 710. In some examples, the first external electrode 620 includes a copper layer 622, a nickel layer 624, and a tin layer 626 sequentially stacked from inside to outside, and the second external electrode 720 includes a copper layer 722, a nickel layer 724, and a tin layer 726 sequentially stacked from inside to outside. In some exemplary examples, a distance G between each of a bottom surface 622b of the copper layer 622 and a bottom surface 722b of the copper layer 722 and a bottom surface 500b of the second insulating protection layer 500 is greater than 5 μm. With such a size sign, the excessive solder paste can be prevented from entering between the second insulating protection layer 500 and the circuit board to prevent the connection between the resistor 10 and the external circuit board from being affected.

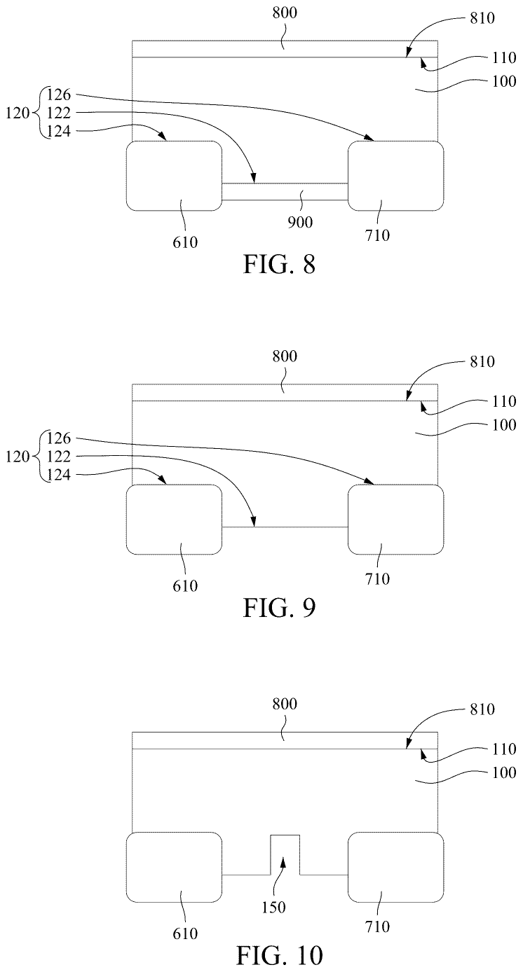

Referring to FIG. 5 through FIG. 14, FIG. 5 through FIG. 14 are schematic cross-sectional views respectively showing intermediate stages in a method for manufacturing a resistor 10 in accordance with one embodiment of the present disclosure. In the manufacturing of the resistor 10 shown in FIG. 1 to FIG. 4, a carrier 800 may be provided first, and the carrier 800 can be used to carry the resistance layer 100. In some examples, the carrier 800 is a single-sided removable carrier film. Specifically, as shown in FIG. 5, a surface 810 of the carrier 800 is sticky, the first surface 110 of the resistance layer 100 is adhered to the surface 810, and the carrier 800 can be peeled off from the first surface 110.

Next, as shown in FIG. 7, portions of the resistance layer 100 may be removed to form a first concave C1 and a second concave C2 in the first end portion 124 and the second end portion 126 of the second surface 120 respectively. In some examples, as shown in FIG. 6, an etching mask layer 900 is first formed to cover the central portion 122 of the second surface 120 of the resistance layer 100 by, for example, printing, laminating, coating, or photolithography. The etching mask layer 900 is a patternable and removable etch-resistant protection layer. For example, a material of the etching mask layer 900 may be photoresist, a removable adhesive film, or a removable ink. The first end portion 124 and the second end portion 126 of the second surface 120 that are not covered by the etching mask layer 900 are internal electrode regions. An etching solution for alloy metal, such as ferric chloride, copper chloride, sulfuric acid, phosphoric acid, or nitric acid, is then used to etch the first end portion 124 and the second end portion 126 of the second surface 120 of the resistance layer 100 that are not covered by the etching mask layer 900, to respectively form the first concave C1 and the second concave C2 in the first end portion 124 and the second end portion 126. In some examples, a depth D of the first concave C1 and the second concave C2 is controlled to be ranging from 20 μm to 50 μm.

Then, as shown in FIG. 8, the first internal electrode 610 and the second internal electrode 710 are respectively formed in the first concave C1 and the second concave C2 by using, for example, electroplating. Thus, the first internal electrode 610 and the second internal electrode 710 can be embedded in the resistance layer 100, thereby reducing the thickness increase caused by using electroplating to grow the electrodes, and decreasing the thickness of the resistor 10.

After the first internal electrode 610 and the second internal electrode 710 are formed, the etching mask layer 900 may be removed by using, for example, a stripping solvent or a water washing method to expose the central portion 122 of the second surface 120, as shown in FIG. 9.

Next, according to product requirements, a trimming operation may be selectively performed on the central portion 122 of the second surface 120 of the resistance layer 100 to adjust a resistance value of the resistance layer 100. As shown in FIG. 10, the trimming operation removes at least a portion of the resistance layer 100 and forms at least one trimming groove 150 in the resistance layer 100. For example, laser or physical processing methods may be used to perform the trimming operation. After the trimming operation is completed, as shown in FIG. 11, the carrier 800 may be removed from the first surface 110 of the resistance layer 100 by, for example, stripping.

As shown in FIG. 12, after the carrier 800 is removed, the first insulating protection layer 200 and the second insulating protection layer 500 may be respectively formed on the central portion 112 of the first surface 110 and the central portion 122 of the second surface 120 by, for example, printing, lamination, or photolithography. The first internal electrode 610 and the second internal electrode 710 have been respectively formed in the first end portion 124 and the second end portion 126 of the second surface 120, such that the second insulating protection layer 500 is formed to cover the central portion 122 between the first internal electrode 610 and the second internal electrode 710 in a caulking manner and fills into the trimming groove 150.

The bottom surface 500b of the second insulating protection layer 500 may be flush with a bottom surface 610b of the first internal electrode 610 and a bottom surface 710b of the second internal electrode 710. Alternatively, as shown in FIG. 12, the bottom surface 500b of the second insulating protection layer 500 may be higher than the bottom surface 610b of the first internal electrode 610 and the bottom surface 710b of the second internal electrode 710 to form a recessed area between the first internal electrode 610 and the second internal electrode 710.

Details such as the shapes, the arrangement positions, and the size designs of the first insulating protection layer 200 and the second insulating protection layer 500 have been described above with reference to FIG. 15 and FIG. 16, and will not be repeated here.

Next, as shown in FIG. 13 and FIG. 17, the first thermal conductive layer 300 and the second thermal conductive layer 400 may be formed on the first surface 110 of the resistance layer 100 and the first insulating protection layer 200 by, for example, printing or sputtering. In the example that uses printing, a material of the first thermal conductive layer 300 and the second thermal conductive layer 400 may be a mixture of epoxy resin and silver. In the example that uses sputtering, the material of the first thermal conductive layer 300 and the second thermal conductive layer 400 may be copper. Details such as the shapes, the arrangement positions, and the size designs of the first thermal conductive layer 300 and the second thermal conductive layer 400 have been described above with reference to FIG. 4 and FIG. 17, and will not be repeated here.

Subsequently, as shown in FIG. 4, the first external electrode 620 and the second external electrode 720 are formed by, for example, electroplating to complete the manufacturing of the resistor 10. The first external electrode 620 extends from the first thermal conductive layer 300 through the first end surface 130 of the resistance layer 100 to the first internal electrode 610 and covers the first thermal conductive layer 300 and the first internal electrode 610. The second external electrode 720 extends from the second thermal conductive layer 400 through the second end surface 140 to the second internal electrode 710 and covers the second thermal conductive layer 400 and the second internal electrode 710. In some examples, each of the first external electrode 620 and the second external electrode 720 may be a multi-layer structure, as described above with reference to FIG. 4. The first external electrode 620 and the second external electrode 720 may be first electroplated to form the copper layers 622 and 722, as shown in FIG. 14. Then, the nickel layers 624 and 724 and the tin layers 626 and 726 are electroplated on the copper layers 622 and 722 respectively.

According to the above embodiments, the first thermal conductive layer 300 and the second thermal conductive layer 400 of the resistor 10 of the present disclosure can increase the heat dissipation area and directly contact the resistance layer 100, such that the heat generated by the resistance layer 100 can be quickly dissipated. Thus, the resistor 10 can be used as a high power current sensing resistor. In addition, the insulating bonding layer is eliminated, such that the resistor 10 can be effectively thinned. Furthermore, the first internal electrode 610 and the second internal electrode 710 are embedded in the resistance layer 100, such that the thickness of the resistor 10 can be further reduced to achieve a thinning effect.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A resistor, comprising:
a resistance layer having a first surface and a second surface that are opposite to each other, and a first end surface and a second end surface that are opposite to each other, wherein each of the first surface and the second surface comprises a central portion, and a first end portion and a second end portion respectively located on two opposite sides of the central portion;
a first insulating protection layer disposed on the central portion of the first surface;
a first thermal conductive layer and a second thermal conductive layer respectively extending from the first end portion and the second end portion of the first surface to the first insulating protection layer and separated from each other;
a second insulating protection layer disposed on the central portion of the second surface, wherein a length of the first insulating protection layer is greater than a length of the second insulating protection layer;
a first terminal electrode structure covering the first thermal conductive layer, the first end surface, the first end portion of the second surface, and a portion of the second insulating protection layer; and
a second terminal electrode structure opposite to and separated from the first terminal electrode structure, and covering the second thermal conductive layer, the second end surface, the second end portion of the second surface, and another portion of the second insulating protection layer.

2. The resistor of claim 1, wherein a difference between the length of the first insulating protection layer and the length of the second insulating protection layer is equal to or greater than 100 μm.

3. The resistor of claim 1, wherein the length of the second insulating protection layer is ranging from ⅕ to ⅗ of a length of the resistance layer.

4. The resistor of claim 1, wherein each of the first thermal conductive layer and the second thermal conductive layer comprises:
a first portion; and
a second portion connected to the first portion to form a T-shaped structure, wherein a width of the second portion is smaller than a width of the first portion,
wherein the second portion of the first thermal conductive layer and the second portion of the second thermal conductive layer are opposite to each other.

5. The resistor of claim 4, wherein a distance between the first thermal conductive layer and the second thermal conductive layer is ranging from ⅕ to ⅓ of a length of the resistance layer, the width of the first portion is ranging from ⅘ to 1 of a width of the resistance layer, and a difference between the width of the first portion and the width of the second portion is ranging from 100 μm to 200 μm.

6. The resistor of claim 1, wherein the first terminal electrode structure comprises a first internal electrode and a first external electrode covering the first internal electrode, the second terminal electrode structure comprises a second internal electrode and a second external electrode covering the second internal electrode, the first internal electrode and the second internal electrode are respectively embedded in the first end portion and the second end portion of the second surface, the first external electrode extends from the first thermal conductive layer through the first end surface to the first internal electrode, and the second external electrode extends from the second thermal conductive layer through the second end surface to the second internal electrode.

7. The resistor of claim 6, wherein each of the first external electrode and the second external electrode comprises a copper layer, a nickel layer, and a tin layer sequentially stacked from inside to outside, and a distance between a bottom surface of the copper layer and a bottom surface of the second insulating protection layer is greater than 5 μm.

8. A method for manufacturing a resistor, comprising:
using a carrier to carry a resistance layer, wherein the resistance layer has a first surface and a second surface that are opposite to each other, and a first end surface and a second end surface that are opposite to each other, and the first surface is adhered to the carrier, and wherein each of the first surface and the second surface comprises a central portion, and a first end portion and a second end portion respectively located on two opposite sides of the central portion;
removing portions of the resistance layer to form a first concave and a second concave in the first end portion and the second end portion of the second surface respectively;
forming a first internal electrode and a second internal electrode in the first concave and the second concave respectively;
removing the carrier;
forming a first insulating protection layer and a second insulating protection layer on the central portion of the first surface and the central portion of the second surface respectively, wherein a length of the first insulating protection layer is greater than a length of the second insulating protection layer;
forming a first thermal conductive layer and a second thermal conductive layer, wherein the first thermal conductive layer and the second thermal conductive layer respectively extend from the first end portion and the second end portion of the first surface to the first insulating protection layer and are separated from each other; and
forming a first external electrode and a second external electrode, wherein the first external electrode extends from the first thermal conductive layer through the first end surface to the first internal electrode, and the second external electrode extends from the second thermal conductive layer through the second end surface to the second internal electrode.

9. The method for manufacturing a resistor of claim 8, wherein a depth of each of the first concave and the second concave is ranging from 20 μm to 50 μm.

10. The method for manufacturing a resistor of claim 8, wherein before forming the first insulating protection layer and the second insulating protection layer, the method for manufacturing a resistor further comprises performing a trimming operation on the central portion of the second surface of the resistance layer to remove a portion of the resistance layer.

11. The method for manufacturing a resistor of claim 8, wherein a difference between the length of the first insulating protection layer and the length of the second insulating protection layer is equal to or greater than 100 μm.

12. The method for manufacturing a resistor of claim 8, wherein forming the first thermal conductive layer and the second thermal conductive layer comprises using a printing method or a sputtering method.

13. The method for manufacturing a resistor of claim 8, wherein each of the first thermal conductive layer and the second thermal conductive layer comprises:
a first portion; and
a second portion connected to the first portion to form a T-shaped structure, wherein a width of the second portion is smaller than a width of the first portion,
wherein the second portion of the first thermal conductive layer and the second portion of the second thermal conductive layer are opposite to each other.

14. The method for manufacturing a resistor of claim 13, wherein a distance between the first thermal conductive layer and the second thermal conductive layer is ranging from ⅕ to ⅓ of a length of the resistance layer, the width of the first portion is ranging from ⅘ to 1 of a width of the resistance layer, and a difference between the width of the first portion and the width of the second portion is ranging from 100 μm to 200 μm.

15. The method for manufacturing a resistor of claim 8, wherein each of the first external electrode and the second external electrode comprises a copper layer, a nickel layer, and a tin layer sequentially stacked from inside to outside, and a distance between a bottom surface of the copper layer and a bottom surface of the second insulating protection layer is greater than 5 μm.
